(19) United States
(12) Patent Application Publication
(10) Pub. No.: US 2009/0266508 A1
(43) Pub. Date: Oct. 29, 2009

(54) Cooling apparatus for a fuel cell powered vehicle

(76) Inventor: Toshiyuki Furuta, Shizuoka-ken (JP)

Correspondence Address: FLYNN THIEL BOUTELL & TANIS, P.C., 2026 RAMBLING ROAD, KALAMAZOO, MI, 49008-1631, US

(21) Appl. No.: 12/456,999

(22) Filed: Jun. 25, 2009

(30) Foreign Application Priority Data
Apr. 7, 2008 (JP) 2008-175256

(51) Int. Cl. F28D 1/00; H01M 8/04

(52) U.S. Cl. 165/44; 429/26

(57) ABSTRACT

A cooling apparatus for a fuel cell powered vehicle includes a first cooling passage for providing cooling water between a fuel cell and a first radiator and a second cooling passage for providing cooling water between electric apparatuses other than the fuel cell and a second radiator. The first radiator is arranged behind a front bumper and in a center portion in a vehicle width direction, a pair of radiators constructing the second radiator are arranged in side portions in the vehicle width direction from the first radiator and in a space surrounded by curved portions of the front bumper. When the vehicle is viewed from an upper direction, each second radiator is curved along an inner surface of the front bumper, and inner edge portions of the second radiators are coupled by a cooling water piping.

### FIELD OF THE INVENTION

The invention relates to a cooling apparatus for a fuel cell powered vehicle and, more particularly, to a cooling apparatus for a fuel cell powered vehicle to improve radiating performance of a radiator arranged in a front portion of the vehicle.

### BACKGROUND OF THE INVENTION

In fuel cell powered vehicles in the related art, a first cooling passage for cooling a fuel cell main body and a second cooling passage for cooling electric apparatuses such as a motor, an inverter, and the like are independently formed. A main reason why such a construction is used is that a super-low electric conductivity is required for cooling water flowing in the first cooling passage.

As for the fuel cell, its heat generation amount is larger than those of other electric apparatuses and it is necessary that a first radiator arranged in the first cooling passage is set to be larger than a second radiator arranged in the second cooling passage.

In the fuel cell powered vehicle in the related art, JP-A-2004-168193 discloses a construction with a first radiator arranged behind a front bumper where a radiation area can be easily assured and in a center portion in a vehicle width direction and a second radiator is divided into two radiators and is arranged in both side portions in the vehicle width direction of the first radiator and in a space surrounded by curved portions of side portions in the vehicle width direction of the front bumper.

However, in the case of arranging the second radiator into such a narrow space as mentioned above, there is an inconvenience in that for a radiator having a flat shape, it is difficult to ensure a necessary radiation area. The second radiator has to be arranged at a position that is away from an opening portion of the front bumper and is difficult to keep in a cooling wind. Thus radiating performance of the second radiator deteriorates.

As further disclosed in JP-A-2004-168193, in the case where a branch point and a confluent point are provided for a cooling water passage of the second cooling passage and the second radiators are respectively arranged in parallel on the two cooling water passages for communicating the branch point and the confluent point, there is an inconvenience in that a structure of the cooling water passages becomes complicated due to the branch point and the confluent point. Therefore mounting efficiency to the vehicle deteriorates.

Further, in the case of cooling the second radiators by cooling fans, there is an inconvenience since the temperatures of the cooling water which flow into the two second radiators are almost equal. Unless the cooling fans are attached to both of the second radiators, it is difficult to remarkably improve the radiating performance.

JP-A-2005-75216 discloses another prior art document of interest.

In a cooling apparatus of a fuel cell powered vehicle, an object of the invention is to improve radiating performance of radiators, to simplify a structure of cooling water passages, and to improve mounting efficiency to a vehicle.

### SUMMARY OF THE INVENTION

To eliminate the above inconvenience, there is provided a cooling apparatus for a fuel cell powered vehicle in which a first cooling passage for circulating cooling water between a fuel cell and a first radiator and a second cooling passage for circulating the cooling water between an electric apparatus other than the fuel cell and a second radiator are respectively independently formed, the first radiator is arranged behind a front bumper and in a center portion in a vehicle width direction, the second radiator is constructed by a pair of radiators arranged in side portions in the vehicle width direction of the first radiator and in a space surrounded by curved portions of side portions in the vehicle width direction of the front bumper, and the first radiator and the second radiator are cooled by a cooling wind introduced from an opening portion formed in the front bumper. When a vehicle is seen from an upper direction, each of the second radiators is curved along an inner surface of the front bumper, wherein inner edge portions in the vehicle width direction of the second radiators are coupled by a cooling water piping, and the cooling water is supplied in one direction from an outer edge portion in the vehicle width direction of one of the second radiators toward an outside portion in the vehicle width direction of the other second radiator.

As described in detail above, according to the invention, there is provided a cooling apparatus of a fuel cell powered vehicle in which a first cooling passage for circulating cooling water between a fuel cell and a first radiator and a second cooling passage for circulating the cooling water between an electric apparatus other than the fuel cell and a second radiator are respectively independently formed. The first radiator is arranged behind a front bumper and in a center portion in a vehicle width direction, the second radiator is constructed by a pair of radiators arranged in side portions in the vehicle width direction of the first radiator and in a space surrounded by curved portions of side portions in the vehicle width direction of the front bumper, and the first radiator and the second radiator are cooled by a cooling wind which is introduced from an opening portion formed in the front bumper. When a vehicle is seen from an upper direction, each of the second radiators is curved along an inner surface of the front bumper, inner edge portions in the vehicle width direction of the second radiators are coupled by a cooling water piping, and the cooling water is supplied in one direction from an outer edge portion in the vehicle width direction of one of the second radiators toward an outside portion in the vehicle width direction of the other second radiator.

Therefore, when the vehicle is seen from the upper direction, since each of the second radiators is curved along the inner surface of the front bumper and the inner edge portions in the vehicle width direction of the second radiators are coupled by the cooling water piping, dimensions of the second radiator which is arranged in the narrow space can be enlarged and the radiation area can be maximally assured.

The second radiators and the cooling water piping can be arranged in the front portion of the vehicle which is able to keep in the cooling wind so that a cooling effect of the second radiators can be improved.

Further, by supplying the cooling water from the outer edge portion in the vehicle width direction of one of the second radiators toward the outside portion in the vehicle width direction of the other second radiator, as compared with the structure in which the cooling water passage is branched and the two second radiators are arranged in parallel, the number of branch and confluent points of the cooling water passage is reduced, the structure of the cooling water passage is simplified, and the mounting efficiency to the vehicle can be improved.

By the above structure, the radiating performance of the second radiators which are mounted in the fuel cell powered vehicle is improved, the structure of the cooling water passage is simplified, and the mounting efficiency to the vehicle can be improved.

### BRIEF DESCRIPTION OF THE DRAWINGS

FIG. 1 is a plan view of a front portion of a fuel cell powered vehicle showing an embodiment of the invention.

FIG. 2 is a front perspective view of a fuel cell powered vehicle.

FIG. 3 is a front perspective view of a fuel cell powered vehicle in a state where a front bumper has been removed.

FIG. 4A is a schematic front view of a first radiator and a second radiator which are arranged in the front portion of the fuel cell powered vehicle.

FIG. 4B is a cross sectional view taken along the line A-A in FIG. 4A.

### DETAILED DESCRIPTION OF THE INVENTION

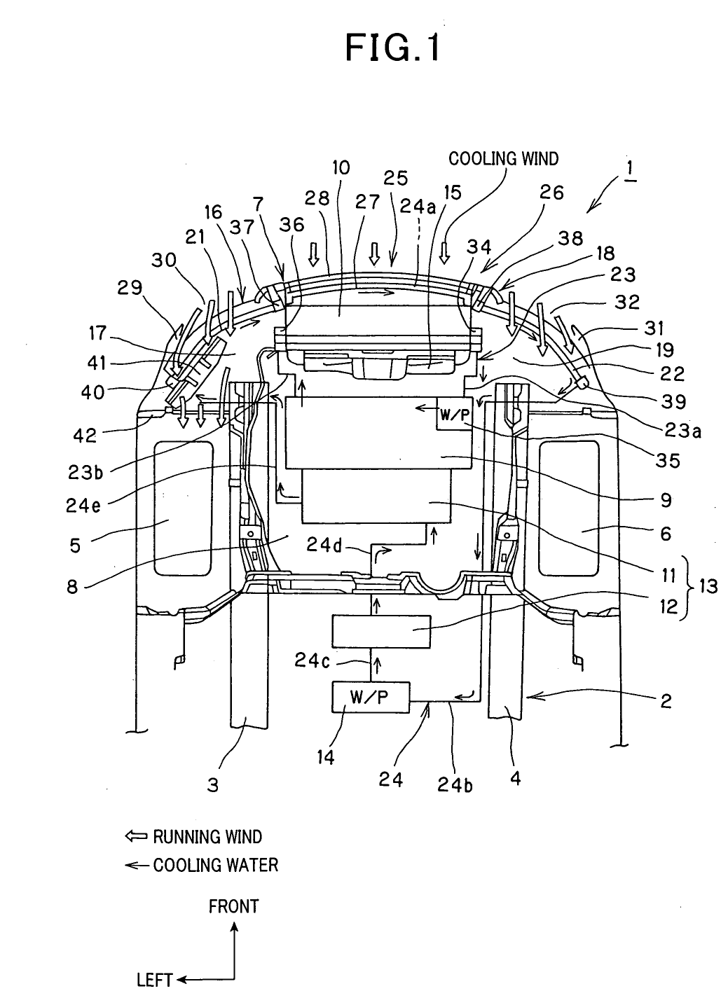

FIGS. 1 to 4 illustrate an embodiment of the invention. FIGS. 1 to 3 show a fuel cell powered vehicle 1.

A vehicle body 2 of the fuel cell powered vehicle 1 has a pair of side frames extending in the vehicle front/rear direction as shown in FIGS. 1 to 3, that is, a left-side frame 3 and a right-side frame 4.

Left and right front wheels 5 and 6 are respectively arranged in outside portions of front portions of the left-side frame 3 and the right-side frame 4. A front bumper 7 is arranged in the front portions of the left-side frame 3 and the right-side frame 4.

An engine room 8 is formed in the front portion of the fuel cell powered vehicle 1.

As shown in FIGS. 1 to 3, a fuel cell 9 is mounted in a center portion in the vehicle width direction in the engine room 8 in a laterally mounting state so that a longitudinal direction is oriented transverse to the vehicle width direction. In the front portion of the fuel cell 9, a first radiator 10 is arranged behind the front bumper 7 and in the center portion oriented in the vehicle width direction. Electric apparatuses 13 such as motor 11, inverter (also referred to as a “motive power control unit”) 12, and the like are sequentially arranged behind the fuel cell 9. A water pump 14 is arranged behind the inverter 12. Further, a cooling fan 15 is arranged behind the first radiator 10.

A pair of second radiators 20 are arranged in a left-side space 17 surrounded by the side portion in the vehicle width direction of the first radiator 10 and a curved portion, for example, a left-side curved portion 16 of a side portion in the vehicle width direction of the front bumper 7 and in a right-side space 19 surrounded by the side portion in the vehicle width direction of the first radiator 10 and a curved portion, for example, a right-side curved portion 18 of a side portion in the vehicle width direction of the front bumper 7.

That is, a left-side second radiator 21 is arranged in the left-side space 17 and a right-side second radiator 22 is arranged in the right-side space 19.

A first cooling passage 23 for circulating the cooling water between the fuel cell 9 and the first radiator 10 and a second cooling passage 24 for circulating the cooling water between the electric apparatuses 13 other than the fuel cell 9 and the second radiators 20 (21, 22) are respectively independently formed.

A cooling apparatus 26 of the fuel cell powered vehicle 1 is constructed so that the first radiator 10 and the second radiators 20 are cooled by the cooling wind which is introduced from an opening portion 25 formed in the front bumper 7.

At this time, when the fuel cell powered vehicle 1 is seen from the upper direction, each second radiator 20, that is, the left-side second radiator 21 and the right-side second radiator 22 are curved along the inner surface of the front bumper 7. Inner edge portions in the vehicle width direction of the left-side second radiator 21 and the right-side second radiator 22 serving as second radiator 20 are coupled by a cooling water piping 27. The cooling water is supplied in one direction from the outer edge portion in the vehicle width direction of one of the second radiators, for example, the left-side second radiator 21 toward the outside portion in the vehicle width direction of the other second radiator, for example, the right-side second radiator 22.

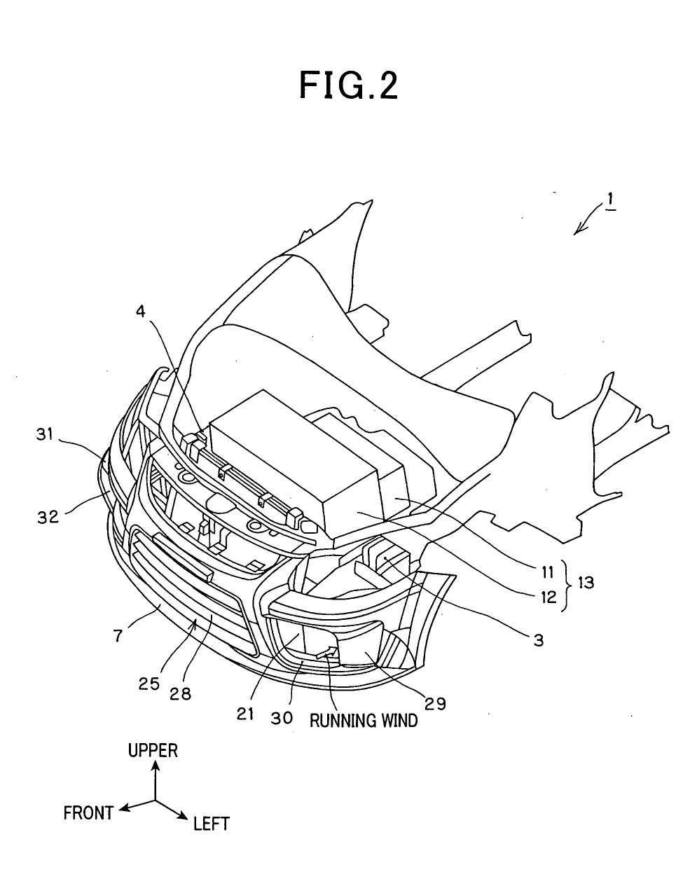

Explaining in detail, as shown in FIGS. 1 and 2, both side portions in the vehicle width direction of the front bumper 7 are curved toward a rear position of the vehicle. The opening portion 25 for introducing the cooling wind is formed in each of the center portion in the vehicle width direction of the front bumper 7 and the left-side curved portion 16 and right-side curved portion 18 in both side portions in the vehicle width direction.

That is, the opening portion 25 is constructed by: a center opening portion 28 which is formed in the center portion in the vehicle width direction of the front bumper 7; a left-side opening portion 30 which is formed in a left-side air guide portion 29 in the left-side curved portion 16 of a left-side portion in the vehicle width direction of the front bumper 7; and a right-side opening portion 32 which is formed in a right-side air guide portion 31 in the right-side curved portion 18 of a right-side portion in the vehicle width direction of the front bumper 7.

As shown in FIG. 2, the left-side air guide portion 29 and the right-side air guide portion 31 are formed in the outside portions in the vehicle width direction of the left-side opening portion 30 and the right-side opening portion 32 on both of the left and right sides of the front bumper 7 so as to be protruded step by step from the surface of the front bumper 7, thereby enabling the running wind flowing in the vehicle width direction along the front portions of the left-side second radiator 21 and the right-side second radiator 22 serving as a second radiator 20 to be captured and enabling the running wind to pass through the left-side second radiator 21 and the right-side second radiator 22. Consequently, an amount of cooling wind passing through the left-side second radiator 21 and the right-side second radiator 22 serving, in combination, as a second radiator 20 can be increased.

By a radiator core supporting member 33 which forms a part of the engine room 8, the first radiator 10 is arranged behind the center opening portion 28 formed in the center portion in the vehicle width direction of the front bumper 7.

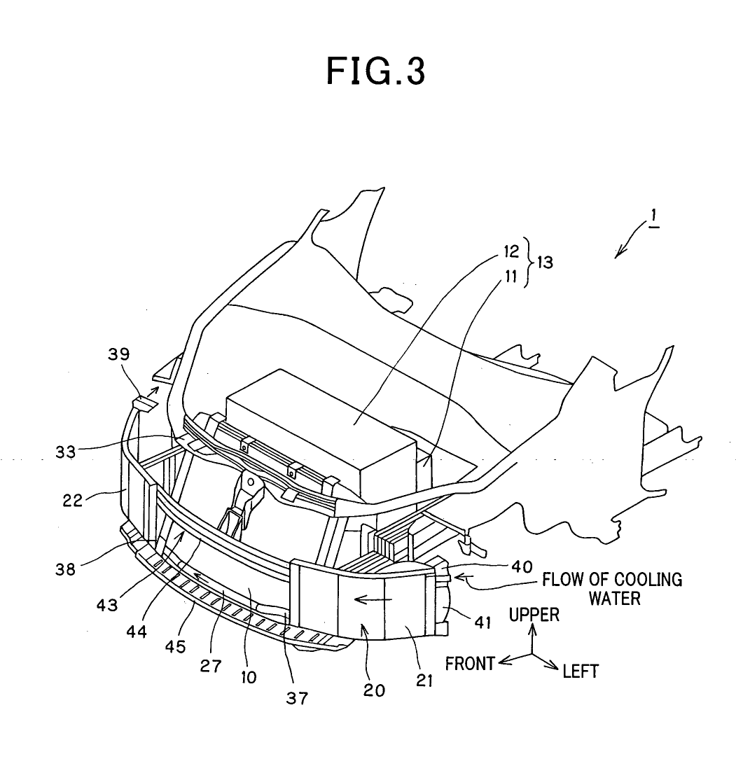

At this time, as shown in FIGS. 1 and 3, the first radiator 10 is arranged in an inclined state so that an upper edge side is located less toward a rear position of the vehicle than a lower edge side.

The left-side second radiator 21 is arranged behind the left-side opening portion 30 formed in the left-side curved portion 16 of the left-side portion in the vehicle width direction of the front bumper 7. The right-side second radiator 22 is arranged behind the right-side opening portion 32 formed in the right-side curved portion 18 of the right-side portion in the vehicle width direction of the front bumper 7.

At this time, since the left-side second radiator 21 and the right-side second radiator 22 serving, in combination, as a second radiator 20 are formed in the shape which is curved along an inner peripheral wall of the front bumper 7, as compared with the radiator of the flat shape, the radiation area can be increased and can be arranged at positions close to the left-side opening portion 30 and the right-side opening portion 32 which are formed in the left-side curved portion 16 and the right-side curved portion 18 of the front bumper 7, respectively. They have such a structure that it is easy to keep in the cooling wind flowing into the left-side opening portion 30 and the right-side opening portion 32.

Since the left-side second radiator 21 and the right-side second radiator 22 are curved, a rear space of each of the left-side second radiator 21 and the right-side second radiator 22 can be enlarged. The cooling wind which has passed through the left-side second radiator 21 and the right-side second radiator 22 can be smoothly ejected toward behind the vehicle.

A cooling water passage of the cooling apparatus 26 of the fuel cell powered vehicle 1 will now be described.

As shown in FIG. 1, the first cooling passage 23 for circulating the cooling water between the fuel cell 9 and the first radiator 10 is constructed by: a (1-1)th passage 23a for communicating with a cooling water exit 34 located on the right side of the first radiator 10 with a water pump 35 for the fuel cell provided on the entrance side of the fuel cell 9; and a (1-2)th passage 23b for communicating the fuel cell 9 with a cooling water entrance 36 located on the left side of the first radiator 10.

That is, the cooling water in the first radiator 10 is fed from cooling water exit 34 located on the right side of the first radiator 10, passes through the (1-1)th passage 23a, and reaches the water pump 35 for the fuel cell. Subsequently, the cooling water is fed from the water pump 35 for the fuel cell and the fuel cell 9, passes through the (1-2)th passage 23b, and reaches the cooling water entrance 36 located on the left side of the first radiator 10.

Thus, the cooling water in the first radiator 10 is cooled by the cooling wind which is introduced from the center opening portion 28 formed in the center portion in the vehicle width direction of the front bumper 7 and the cooled cooling water cools only the fuel cell 9 by using the first cooling passage 23, so that the fuel cell 9 can be certainly cooled and the performance of the fuel cell 9 can be maintained.

As shown in FIGS. 1 and 3, the second cooling passage 24 for circulating the cooling water between the electric apparatuses 13 and the second radiators 20 is constructed by: a (2-1)th passage 24a for communicating a left-side cooling water exit 37 which is formed in a lower portion of the left-side second radiator 21 with a right-side cooling water entrance 38 which is formed in a lower portion of the right-side second radiator 22; a (2-2)th passage 24b for communicating a right-side cooling water exit 39 which is formed in an upper portion of the right-side second radiator 22 with the water pump 14; a (2-3)th passage 24c for communicating the water pump 14 with the inverter 12 as an electric apparatus 13; a (2-4)th passage 24d for communicating the inverter 12 with the motor 11; and a (2-5)th passage 24e for communicating the motor 11 with a left-side cooling water entrance 40 which is formed in an upper portion of the left-side second radiator 21.

That is, the cooling water in the left-side second radiator 21 is supplied from the left-side cooling water exit 37 formed in the lower portion of the left-side second radiator 21, passes through the (2-1)th passage 24a, and reaches the right-side cooling water entrance 38 formed in the lower portion of the right-side second radiator 22. The cooling water is supplied from the right-side cooling water exit 39 formed in the upper portion of the right-side second radiator 22, passes through the (2-2)th passage 24b, and flows into the water pump 14.

The cooling water supplied into the water pump 14 reaches the inverter 12 as an electric apparatus 13 through the (2-3)th passage 24c and flows from the inverter 12 into the motor 11 through the (2-4)th passage 24d.

The cooling water supplied into the motor 11 flows into the left-side cooling water entrance 40 formed in the upper portion of the left-side second radiator 21 through the (2-5)th passage 24e.

At this time, when the cooling water flows into the left-side cooling water entrance 40 of the left-side second radiator 21, as shown in FIG. 1, the cooling water passes through an attaching position of a cooling fan 41 which is attached to a position near the left-side cooling water entrance 40 of the left-side second radiator 21 and will be described hereinafter.

Thus, the cooling water in the left-side second radiator 21 and the right-side second radiator 22 serving as a second radiator 20 is cooled by the cooling winds which are introduced from the left-side opening portion 30 and the right-side opening portion 32 which are respectively formed in the left-side curved portion 16 and the right-side curved portion 18 of the both side portions in the vehicle width direction of the front bumper 7. The cooled cooling water sequentially cools the electric apparatuses 13, such as inverter 12, motor 11, and the like, by using the second cooling passage 24. Thus, the electric apparatuses 13 can certainly be cooled and the performance of the electric apparatuses 13 can be maintained.

In the second cooling passage 24, the (2-1)th passage 24a portion for communicating the left-side cooling water exit 37 formed in the lower portion of the left-side second radiator 21 with the right-side cooling water entrance 38 formed in the lower portion of the right-side second radiator 22, that is, for communicating the inner edge portions in the vehicle width direction of the left-side second radiator 21 and the right-side second radiator 22 is coupled by the cooling water piping 27.

Thus, the left-side second radiator 21, the right-side second radiator 22, and the cooling water piping 27 can be arranged in the front portion of the fuel cell powered vehicle 1 which is able to get in the cooling wind. A cooling effect of the left-side second radiator 21 and the right-side second radiator 22 serving as a second radiator 20 can be improved.

The cooling water is circulated by using the (2-2)th passage 24b to the (2-5)th passage 24e of the second cooling passage 24 so as to flow in one direction from the right-side cooling water exit 39 serving as an outer edge portion in the vehicle width direction of the right-side second radiator 22 as one of the second radiators toward the left-side cooling water entrance 40 serving as an outer edge portion in the vehicle width direction of the left-side second radiator 21 as the other second radiator.

Thus, by supplying the cooling water in one direction from the left-side cooling water entrance 40 serving as an outer edge portion in the vehicle width direction of the left-side second radiator 21 as one of the second radiators toward the right-side cooling water exit 39 serving as an outer edge portion in the vehicle width direction of the right-side second radiator 22 as the other second radiator, as compared with the structure in which the cooling water passage is branched and the two second radiators are arranged in parallel. The number of branch and confluent points of the cooling water passage is reduced, the structure of the cooling water passage is simplified, and the mounting efficiency to the vehicle can be improved.

Further, in the second radiator 20, the cooling fan 41 is attached only to the second radiator located on the upstream side in the flowing direction of the cooling water, for example, to the left-side second radiator 21.

That is, as shown in FIGS. 1 and 3, the cooling fan 41 is attached in a space behind the left-side second radiator 21 and on the front side of a wheel house inner panel 42 which partitions the left-side front wheel 5 and near the left-side cooling water entrance 40 serving as an outside portion in the vehicle width direction.

Thus, the temperature of the cooling water is reduced step by step by the left-side second radiator 21 and the right-side second radiator 22 serving as two second radiators 20. The left-side second radiator 21, as a second radiator which is arranged on the upstream side in the flowing direction of the cooling water and in which the cooling water having a high temperature flows, is cooled by the cooling fan 41. Thus, the radiating performance of the left-side second radiator 21 and the right-side second radiator 22 serving, in combination, as a second radiator 20 can be improved while decreasing the number of cooling fans 41.

Furthermore, the inner edge portions in the vehicle width direction of the left-side second radiator 21 and the right-side second radiator 22 serving as a second radiator 20 are projected to the vehicle front position more than the first radiator 10 and the cooling water piping 27 communicating the left-side second radiator 21 and the right-side second radiator 22 serving as a second radiator 20 is arranged on the vehicle front side of the first radiator 10.

That is, the first radiator 10 is arranged in the center portion in the vehicle width direction in an inclined state so that an upper edge portion is located less toward the vehicle rear position than a lower edge portion. As shown in FIG. 1, the left-side cooling water exit 37 of the left-side second radiator 21 and the right-side cooling water entrance 38 of the right-side second radiator 22 are located more toward the vehicle front side than the lower edge portion of the first radiator 10.

The cooling water piping 27 communicating between the left-side second radiator 21 and the right-side second radiator 22 serving as a second radiator 20 is arranged on the vehicle front side of the first radiator 10, that is, more toward the vehicle front side than the lower edge portion of the first radiator 10 as shown in FIGS. 1 and 3.

Thus, such a situation wherein the cooling water piping 27 communicating the left-side second radiator 21 and the right-side second radiator 22 serving, in combination, as a second radiator 20 is prevented from being heated by the cooling wind which has passed through the first radiator 10. As compared with the first radiator 10, the radiating performance of the left-side second radiator 21 and the right-side second radiator 22 in which the cooling water of low temperature is circulated can be improved.

A bumper member 43 extending in the vehicle width direction is arranged on the vehicle front side of the first radiator 10 and the cooling water piping 27 communicating the left-side second radiator 21 and the right-side second radiator 22 serving as a second radiator 20 is arranged at the position where it is overlaid to the bumper member 43 in the vehicle vertical direction.

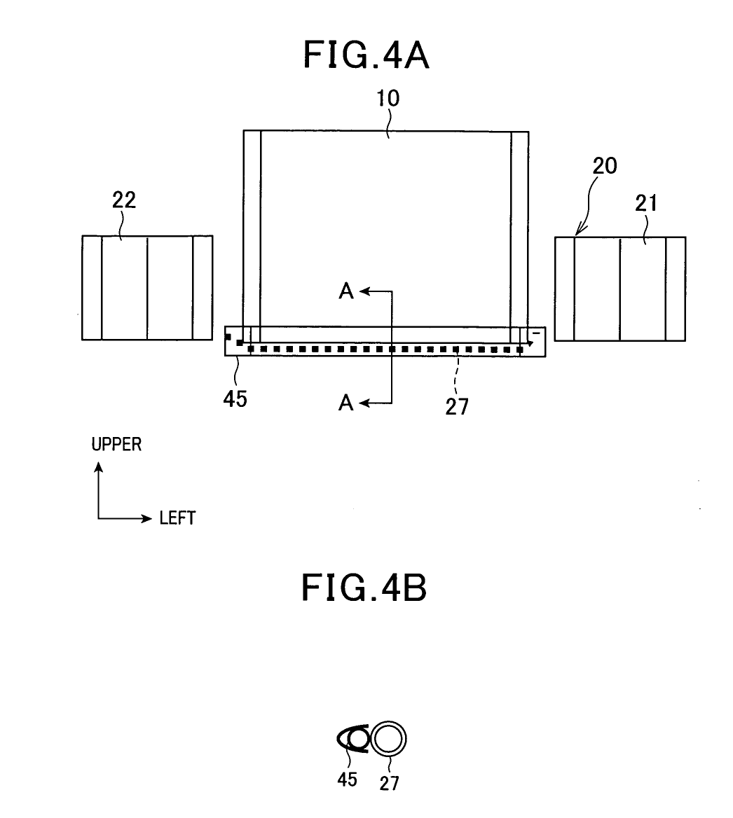

That is, as shown in FIGS. 3, 4A, and 4B, the bumper member 43 is constructed by an upper bumper member 44 and a lower bumper member 45, and the upper bumper member 44 is located over the cooling water piping 27 and is arranged at a position where it is overlaid to the bumper member 43, that is, the lower bumper member 45 in the vehicle vertical direction.

As shown in FIG. 4B, the lower bumper member 45 is formed by being curved in a doglegged cross sectional shape and a center of the curve is projected to the vehicle front position. As shown in FIGS. 4A and 4B, the cooling water piping 27 is located in a rear position serving as an open side of the lower bumper member 45 and is arranged at a position where it is overlaid by the bumper member 43, that is, the lower bumper member 45 even in the vehicle front/rear direction.

Thus, by arranging the cooling water piping 27 to such a position that the cooling wind flowing into the first radiator 10 is not obstructed, the radiating performance of the first radiator 10 can be improved.

Since the front side of the cooling water piping 27 extending in the vehicle width direction in the vehicle front portion is provided so as to be overlaid in the vehicle front/rear direction with the lower bumper member 45, the cooling water piping 27 can be protected at the time of collision of the fuel cell powered vehicle 1.

1. A cooling apparatus for a fuel cell powered vehicle comprising a first cooling passage for circulating cooling water between a fuel cell and a first radiator and a second cooling passage for circulating cooling water between an electric apparatus other than the fuel cell and a second radiator, wherein the first and second radiators are independently formed, said first radiator being arranged behind a front bumper and in a center portion in a vehicle width direction, wherein said second radiator is constructed by a pair of radiators, wherein said pair of radiators are arranged in side portions in the vehicle width direction of said first radiator and in a-space surrounded by curved portions of side portions in the vehicle width direction of the front bumper, and said first radiator and said second radiator are cooled by a cooling wind which is introduced from an opening portion formed in the front bumper, wherein when a vehicle is viewed from an upper direction, each of said second radiators is curved along an inner surface of the front bumper, inner edge portions in the vehicle width direction of said second pair of radiators being coupled by a cooling water piping, and the cooling water is supplied in one direction from an outer edge portion in the vehicle width direction of one of said second pair of radiators toward an outside portion in the vehicle width direction of the other of said second pair of radiators.

2. The cooling apparatus for a fuel cell powered vehicle according to claim 1, wherein in said second pair of radiators, a cooling fan is attached only to the second radiator located on an upstream side in a flowing direction of the cooling water.

3. The cooling apparatus for a fuel cell powered vehicle according to claim 1, wherein the inner edge portion in the vehicle width direction of each of said second pair of radiators is protruded toward a vehicle front position more than a lower edge of the first radiator, and a cooling water piping for communicating between the second pair of radiators is arranged on the vehicle front side of the first radiator.

4. The cooling apparatus for a fuel cell powered vehicle according to claim 3, wherein a bumper member extending in the vehicle width direction is arranged on the vehicle front side of said first radiator and the cooling water piping for communicating between the second pair of radiators is arranged at a position overlaying the bumper member in the vehicle vertical direction.
